(19) United States
(12) Patent Application Publication
(10) Pub. No.: US 2022/0185284 A1
(43) Pub. Date: Jun. 16, 2022

(54) METHOD FOR STARTING OFF A MOTOR VEHICLE

(71) Applicants: Magna PT B.V. & Co. KG, Untergruppenbach (DE); Magna International Inc., Aurora (CA)

(72) Inventors: Huessein DOURRA, Bloomfield, MI (US); Jacques PROST, Heilbronn (DE)

(21) Appl. No.: 17/440,341

(22) PCT Filed: Mar. 11, 2020
(86) PCT No.: PCT/EP2020/056438

§ 371 Date: Sep. 17, 2021

(30) Foreign Application Priority Data
Mar. 20, 2019 (DE) 10 2019 203 804.2

(51) Int. Cl. B60W 30/18; B60W 40/08; B60W 10/06; B60W 10/08; B60W 20/15

(52) U.S. Cl. CPC B60W 30/18027; B60W 40/08; B60W 10/06; B60W 2540/10; B60W 20/15; B60W 2710/083; B60W 2710/0666; B60W 10/08

(57) ABSTRACT

A method for starting off a motor vehicle, wherein the motor vehicle has a drive train, which comprises a hybrid drive unit, a transmission and an accelerator pedal, by means of which a driver can set a driver's desired torque, wherein during the starting off of the motor vehicle the hybrid drive unit is regulated to a total drive torque greater than the driver's desired torque in a first operating phase.

### CROSS-REFERENCE TO RELATED APPLICATIONS

This application is a National Stage of International Application No. PCT/EP2020/056438, filed Mar. 11, 2020, which claims priority to DE102019203804.2, filed Mar. 20, 2019. The entire disclosures of each of the above applications are incorporated herein by reference.

### FIELD OF THE INVENTION

The present invention relates to a method for starting off a motor vehicle, wherein the motor vehicle has a drive train which comprises a hybrid drive unit, a transmission and an accelerator pedal, by means of which a driver can set a driver's desired torque.

### BACKGROUND OF THE INVENTION

This section provides information related to the present disclosure which is not necessarily prior art.

A motor vehicle having an automatic transmission may have different designs. Currently, automatic converter transmissions with a hydrodynamic torque converter and dual clutch transmissions are most frequently installed. In an automatic converter transmission, the hydrodynamic torque converter represents the link between a drive unit, such as an internal combustion engine, and the actual transmission. On the one hand, the torque converter makes it possible to start off in a comfortable, jerk-free manner by virtue of the slip and, at the same time, damps rotational irregularities of the internal combustion engine.

On the other hand, the torque increase due to the principle involved makes available a large starting torque.

Dual clutch transmissions do not have a hydrodynamic torque converter, but two dry or wet starting clutches, which, at the maximum, can transmit the current internal combustion engine torque to the transmission input. Thus, the starting behavior with a dual clutch transmission is less dynamic than with a converter transmission. In order to achieve a starting performance corresponding to a hydrodynamic converter, the gear ratio spread is, according to the prior art, often increased by installing an additional starting gear stage.

However, this has a disadvantageous effect on transmission complexity and the required installation space.

The further development of motor vehicles continues to focus on the hybridization of the drive train. In most cases, this is done by expanding the drive unit by an electric machine.

### SUMMARY OF THE INVENTION

This section provides a general summary of the disclosure, and is not a comprehensive disclosure of its full scope or all of its features.

It is an object of the invention to specify a method for starting off a hybrid motor vehicle by means of which, in particular, sporty and comfortable starting off of the hybrid motor vehicle is possible.

The object is achieved by a method for starting off a motor vehicle, wherein the motor vehicle has a drive train, which comprises a hybrid drive unit, a transmission and an accelerator pedal, by means of which a driver can set a driver's desired torque, wherein during the starting off of the motor vehicle the hybrid drive unit is regulated to a total drive torque greater than the driver's desired torque in a first operating phase.

Further developments of the invention are given in the dependent claims, the description and the accompanying drawings.

The method according to the invention is used in a motor vehicle with a drive train which has a hybrid drive unit, a transmission and an accelerator pedal.

A hybrid drive unit is to be understood to mean essentially a combination of at least two different drive techniques. As a particular preference, the hybrid drive unit has an internal combustion engine and an electric machine, wherein the total drive torque is formed by addition of a first drive torque, namely a drive torque of the internal combustion engine, and a second drive torque, namely a drive torque of the electric machine.

The hybrid drive unit is designed to provide drive power, which can be directed via the transmission to an output and/or directly to an output.

The electric machine can be arranged between the internal combustion engine and the transmission in the direction of power flow. In particular, however, it is also possible to connect the electric machine to the transmission separately from the internal combustion engine, such as, for example, to a transmission shaft of the transmission.

Furthermore, the electric machine can be connected directly to the output. It is also conceivable for the internal combustion engine and the transmission to be arranged on a first vehicle axle, while the electric machine is arranged on an output of a second vehicle axle.

In general, the method according to the invention should not be restricted to possible ways of connecting the drive units to the drive train since the arrangement of the drive units does not have any effect on the method.

The transmission is preferably designed as a stepped transmission known to those skilled in the art of transmissions. However, it is also conceivable to use a planetary transmission in combination therewith or separately.

Use of the method according to the invention is advantageous, in particular, if a hydrodynamic torque converter is not used when using a planetary transmission.

Starting off or the starting-off process of the motor vehicle can be subdivided into two operating phases, namely a first operating phase and a second operating phase. The first operating phase corresponds to an acceleration phase of the motor vehicle in which the total drive torque of the hybrid drive unit is regulated toward a first target drive torque. The first operating phase is considered to be completed as soon as the first target torque of the internal combustion engine corresponds to the driver's desired torque. The second operating phase corresponds to an acceleration phase of the motor vehicle in which the total drive torque of the hybrid drive unit is regulated toward a second target drive torque.

In a refinement of the invention, it is possible for the driver of the motor vehicle to set a driver's desired torque via an accelerator pedal position. Depending on this driver's desired torque, the hybrid drive unit is regulated to a total drive torque that is greater than the driver's desired torque in a first operating phase.

The total drive torque is obtained from the drive torques of the individual drive units of the hybrid drive unit. There need not be a direct relationship between an accelerator pedal position and the driver's desired torque. It is also possible, for example, for the accelerator pedal position to be interpreted as a desired power, a desired rotational speed, or the like, and then a driver's desired torque is derived from this variable.

The hybrid drive unit is preferably regulated to a total drive torque corresponding to the driver's desired torque in the second operating phase.

An automated clutch unit, for example a single clutch, preferably a dual clutch, can be arranged between the internal combustion engine and the transmission.

By using an automated clutch unit, the first drive torque of the internal combustion engine present in the drive train can be controlled in a selective manner. Overall, this improves the control of the total drive torque.

The electric machine can be designed as a 48V machine, for example. In general, it should be noted that, compared to an internal combustion engine, electric machines provide a high torque but little power over a defined period of time. This property is utilized in the present method according to the invention. The torque increase of a hydrodynamic torque converter is replaced by an electric torque of the electric machine to simulate the behavior of a hydrodynamic torque converter. The hybrid drive unit thus preferably comprises at least one electric machine. However, it is also conceivable to replace this by a drive unit or drive technology that has the same or similar properties.

The internal combustion engine is preferably regulated to a first target drive torque during the first operating phase, wherein the first target drive torque corresponds to the driver's desired torque.

Furthermore, the electric machine is preferably regulated to a second target drive torque in the first operating phase, wherein the second target drive torque is less than the driver's desired torque.

The electric machine is preferably regulated to a zero torque during the second operating phase, namely after the internal combustion engine has reached the first target drive torque and/or the electric machine has reached the second target drive torque.

The electric machine is preferably regulated to a generator torque during the second operating phase, namely after the internal combustion engine has reached the first target drive torque and/or the electric machine has reached the second target drive torque.

The second operating phase preferably lasts at least as long as the first operating phase.

If the driver's desired torque changes during the first operating phase, the second drive torque of the electric machine is preferably increased or reduced in accordance with the change.

Furthermore, if the driver's desired torque changes during the first operating phase, the first drive torque of the internal combustion engine can be increased or reduced in accordance with the change, in particular if the electric machine is already making its maximum target torque available at the time of the change in the driver's desired torque.

If the driver's desired torque changes during the second operating phase, the first drive torque of the internal combustion engine is preferably increased or reduced in accordance with the change.

The internal combustion engine is preferably started within the first operating phase. The method according to the invention can therefore be carried out even when the internal combustion engine is not ready for operation or is still switched off owing to an operating strategy. Thus, the total drive torque is briefly supplied only by the electric machine until the internal combustion engine has been started. Overall, starting off can thus be carried out in an accelerated manner since the drive train reacts immediately to the driver's desired torque.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 shows time curves of torques when starting off with the method according to the invention.

FIG. 2 shows the curve of the torque and of the power of an electric machine against the vehicle speed.

FIG. 3 shows an illustrative drive train for carrying out the method according to the invention.

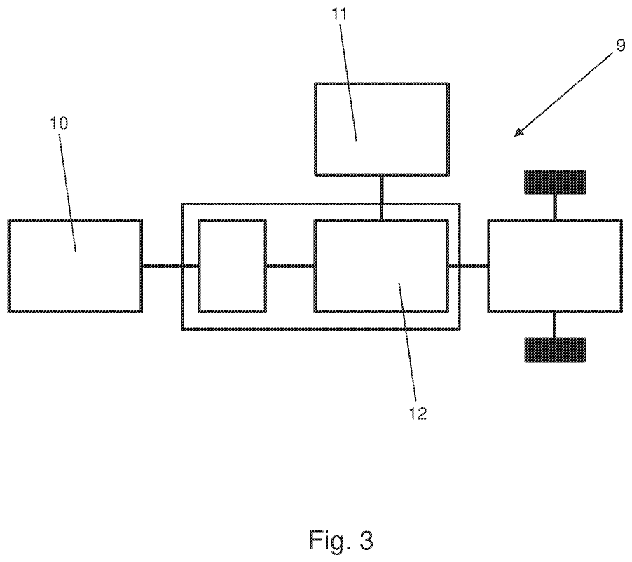

The method according to the invention described below is applied to a motor vehicle having a (hybrid) drive train 9 comprising an internal combustion engine 10, an electric machine 11, namely a 48V machine, a dual clutch transmission 12 and an accelerator pedal (FIG. 3). In the present exemplary embodiment, the hybrid drive unit thus has an internal combustion engine 10 and an electric machine 11. However, it is also conceivable to apply the method according to the invention to some other combination of drive units or drive techniques.

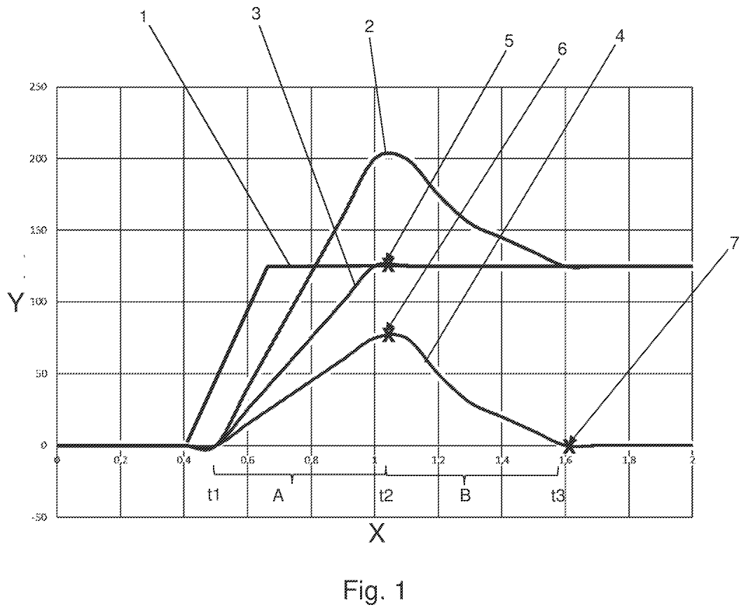

FIG. 1 shows time curves of torques, i.e. the torque Y in newton meters [Nm] against the time X in seconds [s], when starting off a motor vehicle.

The curve of the driver's desired torque is illustrated as a line 1. Line 2 shows the time curve of a total drive torque of the hybrid drive unit. Line 3 shows the time curve of a first drive torque of the internal combustion engine 10. Line 4 shows a time curve of a second drive torque of the electric machine 11. Marking 5 shows a first target drive torque of the internal combustion engine 10. Marking 6 shows a second target drive torque of the electric machine 11. The zero torque of the electric machine 11 is indicated by marking 7.

The curve of the individual drive torques 3, 4 and thus of the total drive torque 2 is dependent on the driver's desired torque 1. The driver selects the driver's desired torque 1 via an accelerator pedal, which can be actuated by the driver. By means of a control unit, the driver's desired torque 1 specified by the driver via the accelerator pedal is sensed, and the starting-off process is controlled. At least one characteristic, by means of which the starting off of the motor vehicle is regulated, is stored in the control unit. That Is to say that the starting off of the motor vehicle is determined by at least one stored characteristic.

The starting-off process is subdivided into two operating phases, namely into a first operating phase A and a second operating phase B. The first operating phase A starts at time t1 and ends at time t2. The second operating phase starts at time t2 and ends at time t3. The entire starting-off process thus starts at a time t1 and ends at a time t3. In the present exemplary embodiment, the two operating phases A, B last for substantially equal length.

The total drive torque 2 represents the sum of the first drive torque 3 of the internal combustion engine 10 and the second drive torque 4 of the electric machine 11.

At time t1, the first drive torque 3 of the internal combustion engine 10 and the second drive torque 4 of the electric machine 11 and thus the total drive torque 2 are equal to zero. During the first operating phase A, the first drive torque 3 of the internal combustion engine 10 is regulated to a first target drive torque 5, which corresponds to the driver's desired torque 1. In addition, during the first operating phase A, the second drive torque 4 of the electric machine 10 is regulated to a second target drive torque 6, which is less than the driver's desired torque 1. At time t2, the first target drive torque 5 and the second target drive torque 6 are reached. The resulting total drive torque 2 of the hybrid drive unit is excessive with respect to the driver's desired torque 1, in particular at time t2. After the first target drive torque 5 and the second target drive torque 6 have been reached, the second operating phase B starts, namely at time t2. In the second operating phase B, the second drive torque 4 of the electric machine 11 is regulated to a zero torque 7. Alternatively, the electric machine 11 can also be switched immediately to a no-load state. The first drive torque 3 of the internal combustion engine 10 is further regulated to the level of the driver's desired torque 1 in the second operating phase B. At time t3, the second drive torque 4 of the electric machine 11 corresponds to the zero torque 7, and the first drive torque 3 of the internal combustion engine 10 corresponds to the driver's desired torque 1. This results in a total drive torque 2 of the hybrid drive unit corresponding to the driver's desired torque 1 at time t3.

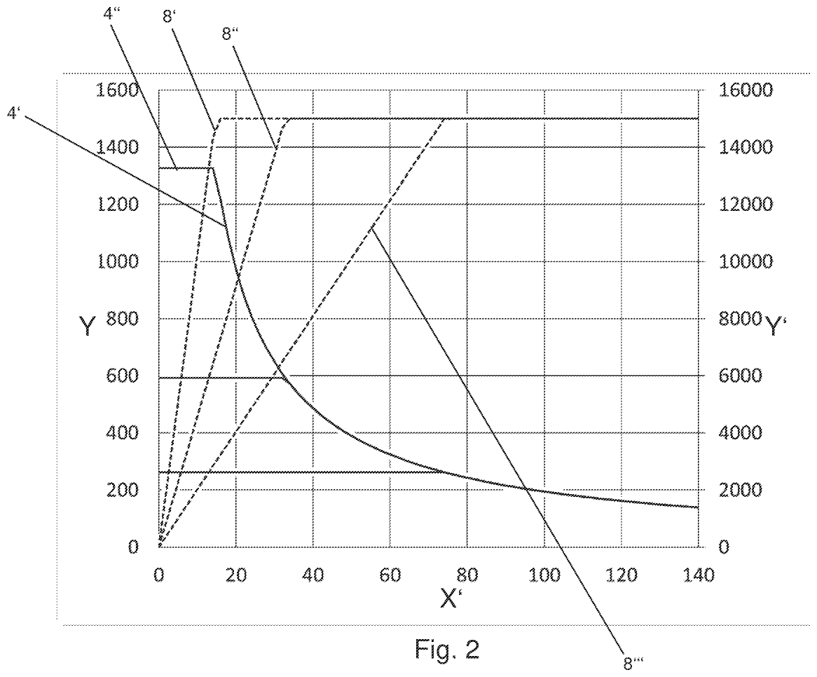

FIG. 2 shows the characteristic curve of the torque Y in newton meters [Nm] of the electric machine 11 and of the power Y′ in watts [W] of the electric machine 11 against the motor vehicle speed X′ in kilometers per hour [km/h] or the rotational speed of the electric machine 11 at different power requirements (dashed lines 8′, 8″, 8″′). In this case, a first dashed line 8′ represents a power requirement which is higher than a second dashed line 8″ and a third dashed line 8″′, which means that the power to be controlled is already achieved at low speeds/rotational speeds. Although the decreasing torque curve 4′ of the electric machine 11 is specified by a substantially parabolic curve, the maximum torque 4″ that can be set can be limited section-by-section by an intervention in the control of the electric machine 11, such as, for example, by a current limitation. The electronics can thereby be protected against overload in the event of a high power requirement, in particular during starting off, and efficient operation of the electric machine 11 can be ensured. Normally, the maximum torque 4″ that can be set is kept constant by the intervention in the control of the electric machine 11, namely until the torque follows the characteristic torque curve 4′.

By an intervention in the control of the electric machine 11, in particular in the case of a 48V machine, a comparatively higher torque is called up during starting off, thus enabling an increased total drive torque 2 to be established in the hybrid drive train 9.

Compliance with a maximum torque 4″ of the electric machine 11 that is to be set is regarded as a mandatory requirement here. The second target drive torque 6 is therefore limited by a maximum second target drive torque. In other words, an increased load on the electronics of the electric machine 11 is to be permitted for a short time by optimized control.

The maximum second target drive torque preferably results from the expected time duration of the first operating phase A, that is to say the time duration which is necessary to accelerate the first target drive torque 5 of the internal combustion engine 10 to the driver's desired torque 1. In order to be able to achieve and maintain the maximum possible torque 4″ over this time range, the maximum second target drive torque is adapted to the characteristic torque curve 4′ in such a way that the second target drive torque 6 of the electric machine 11 can be set to a constant value without a torque drop within operating phase A and/or operating phase B.

Furthermore, the second target drive torque 6 can be brought to the maximum possible second target drive torque, independently of the driver's desired torque 1, during starting off of the motor vehicle. In other words, the electric machine 11 supports the hybrid drive train 9 with the highest possible power when starting off, irrespective of the driver's desired torque 1 demanded.

### LIST OF REFERENCE DESIGNATIONS

1 driver's desired torque
2 total drive torque
3 first drive torque (of the internal combustion engine)
4 second drive torque (of the electric machine)
4′ torque curve (of the electric machine)
4″ maximum torque (of the electric machine) that can be set
5 first target drive torque (of the internal combustion engine)
6 second target drive torque (of the electric machine)
7 zero torque
8′ first dashed line
8″ second dashed line
8′″ third dashed line
9 (hybrid) drive train (for a motor vehicle)
10 internal combustion engine
11 electric machine
12 dual clutch transmission
A first operating phase
B second operating phase
X time in seconds [s]
X′ motor vehicle speed in kilometers per hour [km/h]
Y torque in newton meters [Nm]
Y′ power in watts [W]

What is claimed is:

1. A method for starting off a motor vehicle, wherein the motor vehicle has a drive train, which comprises a hybrid drive unit, a transmission and an accelerator pedal, by means of which a driver can set a driver's desired torque, wherein during the starting off of the motor vehicle the hybrid drive unit is regulated to a total drive torque greater than the driver's de-sired torque in a first operating phase.

2. The method as claimed in claim 1, wherein the hybrid drive unit is regulated to a total drive torque corresponding to the driver's desired torque in a second operating phase.

3. The method as claimed in claim 1, wherein the hybrid drive unit comprises an internal combustion engine and an electric machine, wherein the total drive torque is formed by addition of a first drive torque of the internal combustion engine and a second drive torque of the electric machine.

4. The method as claimed in claim 3, wherein the internal combustion engine is regulated to a first target drive torque during the first operating phase, wherein the first target drive torque corresponds to the driver's desired torque.

5. The method as claimed in claim 3, wherein the electric machine is regulated to a second target drive torque in the first operating phase, wherein the second target drive torque is less than the driver's desired torque.

6. The method as claimed in claim 5, wherein the electric machine is regulated to a zero torque during the second operating phase, namely after the internal combustion engine has reached the first target drive torque and/or the electric machine has reached the second target drive torque.

7. The method as claimed in claim 5, wherein the electric machine is regulated to a generator torque during the second operating phase, namely after the internal combustion engine has reached the first target drive torque and/or the electric machine has reached the second target drive torque.

8. The method as claimed in any of claims 2, characterized in that wherein the second operating phase lasts at least as long as the first operating phase.

9. The method as claimed in any of claims 3, wherein, if the driver's desired torque changes during the first operating phase, the second drive torque of the electric machine is increased or reduced in accordance with the change.

10. The method as claimed in any of claims 3, wherein, if the driver's desired torque changes during the second operating phase, the first drive torque of the internal combustion engine is increased or reduced in accordance with the change.

11. The method as claimed in any of claims 3, wherein the internal combustion engine is started within the first operating phase.
